(19) United States
(12) Patent Application Publication
(10) Pub. No.: US 2017/0156106 A1
(43) Pub. Date: Jun. 1, 2017

(54) METHOD AND APPARATUS FOR RETRIEVING AND DISPLAYING NETWORK STATE INFORMATION

(71) Applicant: Xiaomi Inc., Beijing (CN)

(72) Inventors: Yong CHEN, Beijing (CN); Dingpeng CAO, Beijing (CN); Hongwei GUO, Beijing (CN)

(73) Assignee: Xiaomi Inc., Beijing (CN)

(21) Appl. No.: 15/362,341

(22) Filed: Nov. 28, 2016

(30) Foreign Application Priority Data
Nov. 27, 2015 (CN) 201510846057.8

(51) Int. Cl. H04W 48/14; H04W 72/04

(52) U.S. Cl. CPC H04W 48/14; H04W 72/0446

(57) ABSTRACT

A method and apparatus are provided for retrieving and displaying network state information. The method includes acquiring real-time bandwidth occupation information of bandwidth occupiers associated with a routing device, the bandwidth occupiers having one or more network services on the routing device and at least one electronic device accessing the routing device; generating network state information for the routing device, based on the real-time bandwidth occupation information of the bandwidth occupiers; and sending the network state information for the routing device to a designated device, so that the designated device displays the network state information.

### CROSS-REFERENCE TO RELATED APPLICATION

This application is based on and claims priority to Chinese Patent Application No. 201510846057.8, filed on Nov. 27, 2015, which is incorporated herein by reference in its entirety.

### TECHNICAL FIELD

The present disclosure generally relates to the field of network technology, and more particularly, to methods and apparatuses for retrieving and displaying network state information.

### BACKGROUND

With the development of network technology, a routing device can be used as an accessing device, and network activities can be performed via the routing device. However, while using the routing device, it is common that, although the maximum bandwidth of the routing device can be reached at 10 M/s for example, the actual usable bandwidth provided by the routing device often cannot reach the maximum bandwidth because there are many network activities performed on the routing device. As such, a user may be misled with the maximum bandwidth of the routing device and may wrongfully believe that the network bandwidth for the routing device is higher than it actually is. Thus, due to such misconception, the user may not be able to meet the actual demand for the network bandwidth without knowing the reason. Therefore, there is a need for retrieving and displaying network state information including real-time bandwidth information. However, technical challenges exist for obtaining and displaying network state information for the routing device.

### SUMMARY

According to a first aspect of the disclosure, a network state information retrieval and display method is provided. The method may include: acquiring real-time bandwidth occupation information of each of bandwidth occupiers associated with a routing device, the bandwidth occupiers including one or more network services on the routing device and at least one electronic device accessing the routing device, generating network state information for the routing device, based on the real-time bandwidth occupation information of each bandwidth occupier, and sending the network state information for the routing device to a designated device, so that the designated device displays the network state information.

According to a second aspect of the disclosure, a network state information retrieval and display method is provided, the method may include: receiving network state information for a routing device, and displaying the network state information for the routing device.

According to a third aspect of the disclosure, a network state information retrieval and display apparatus is provided, the apparatus may include an acquiring module configured to acquire real-time bandwidth occupation information of each of bandwidth occupiers associated with a routing device, the bandwidth occupiers including one or more network services on the routing device and at least one electronic device accessing the routing device, a generating module configured to generate network state information of the routing device, based on the real-time bandwidth occupation information of each bandwidth occupier acquired by the acquiring module, and a sending module configured to send the network state information of the routing device generated by the generating module to a designated device, so that the designated device displays the network state information.

According to a fourth aspect of the disclosure, a network state information retrieval and display apparatus is provided, the apparatus may include: a receiving module configured to receive network state information of a routing device, and a display module configured to display the network state information of the routing device received by the receiving module.

According to a fifth aspect of the disclosure, a network state information retrieval and display apparatus is provided, the apparatus may include: a processor, and a memory configured to store instructions executable by the processor. The processor is configured to: acquire real-time bandwidth occupation information of each of bandwidth occupiers associated with a routing device, the bandwidth occupiers including one or more network services on the routing device and at least one electronic device accessing the routing device, generate network state information of the routing device, based on the real-time bandwidth occupation information of each bandwidth occupier, and send the network state information of the routing device to a designated device, so that the designated device displays the network state information.

According to a sixth aspect of the disclosure, a network state information retrieval and display apparatus is provided, the apparatus may include: a processor, and a memory configured to store instructions executable by the processor. The processor may be configured to: receive network state information for a routing device, and display the network state information of the routing device.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing a network state information retrieval and display method according to an exemplary embodiment;

FIG. 2 is a flow chart showing a network state information retrieval and display method according to an exemplary embodiment;

FIG. 3A is a flow chart showing a network state information retrieval and display method according to an exemplary embodiment;

FIG. 3B is a schematic diagram showing a network state information user interface according to an exemplary embodiment;

FIG. 3C is a schematic diagram showing a network state information user interface according to an exemplary embodiment;

FIG. 3D is a schematic diagram showing a network state information user interface according to an exemplary embodiment;

FIG. 4 is a block diagram showing a network state information retrieval and display apparatus according to an exemplary embodiment;

FIG. 5 is a block diagram showing a network state information retrieval and display apparatus according to an exemplary embodiment;

FIG. 6 is a block diagram showing a network state information retrieval and display apparatus 600 according to an exemplary embodiment;

FIG. 7 is a block diagram showing a network state information retrieval and display apparatus 700 according to an exemplary embodiment.

### DETAILED DESCRIPTION

To make the objects, technical solutions and advantages of the present disclosure more clear, embodiments of the present disclosure will be described below in detail with reference to the accompanying drawings.

Reference will now be made in detail to exemplary embodiments, examples of which are illustrated in the accompanying drawings. The following description refers to the accompanying drawings in which the same numbers in different figures represent the same or similar elements unless otherwise indicated. The implementations set forth in the following embodiments do not represent all implementations consistent with the disclosure. Instead, they are merely examples of devices and methods consistent with aspects related to the disclosure as recited in the appended claims.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

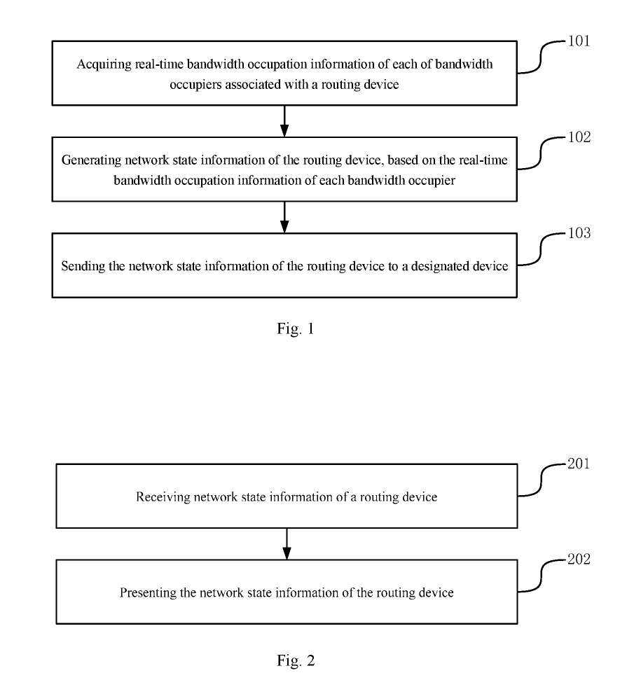

FIG. 1 is a flow chart showing a network state information retrieval and display method. As shown in FIG. 1, the network state information retrieval and display method is used in a routing device and may include the following steps.

In step 101, real-time bandwidth occupation information of each of bandwidth occupiers associated with a routing device is acquired 101. The bandwidth occupiers may include one or more network services on the routing device and at least one electronic device accessing the routing device.

In step 102, network state information of the routing device is generated based on the real-time bandwidth occupation information of each bandwidth occupier 102.

In step 103, the network state information of the routing device is sent to a designated device, so that the designated device presents the network state information 103.

In the method according to this embodiment, by performing statistics on its actually occupied bandwidth, the routing device obtains network state information which characterizes real-time bandwidth occupation and provides the network state information to a terminal, making the network state available to users and avoiding misleading them.

In a possible implementation, generating the network state information of the routing device based on the real-time bandwidth occupation information of each bandwidth occupier may include: for each bandwidth occupier, summing the real-time bandwidth occupation information of the bandwidth occupier to obtain network state information of the bandwidth occupier, and integrating the network state information of the bandwidth occupiers to obtain the network state information for the routing device.

In a possible implementation, acquiring the real-time bandwidth occupation information of each of the bandwidth occupiers associated with the routing device may include: scanning each of the network services on the routing device to obtain real-time bandwidth information of the network service, and scanning a network port between the routing device and each of the at least one electronic device accessing the routing device to obtain real-time bandwidth information of the electronic device.

In a possible implementation, acquiring the real-time bandwidth occupation information of each of the bandwidth occupiers associated with the routing device may include: acquiring the real-time bandwidth occupation information of each of the bandwidth occupiers associated with the routing device, when receiving a network state information acquiring request sent by the designated device, or acquiring the real-time bandwidth occupation information of each of the bandwidth occupiers associated with the routing device at a predetermined period or a predetermined time interval.

In a possible implementation, after sending the network state information of the routing device to the designated device, the method may further include: upon receiving an adjusting instruction for any of the bandwidth occupiers, closing the bandwidth occupier.

In a possible implementation, the real-time bandwidth occupation information indicates a sum of an upload speed and a download speed, or alternatively, a first sum of the upload speed and a second sum of the download speed and the first sum and the second sum are shown separately.

All the above optional solutions may be combined in any manner to form an optional embodiment of the present disclosure, which will not be described here redundantly.

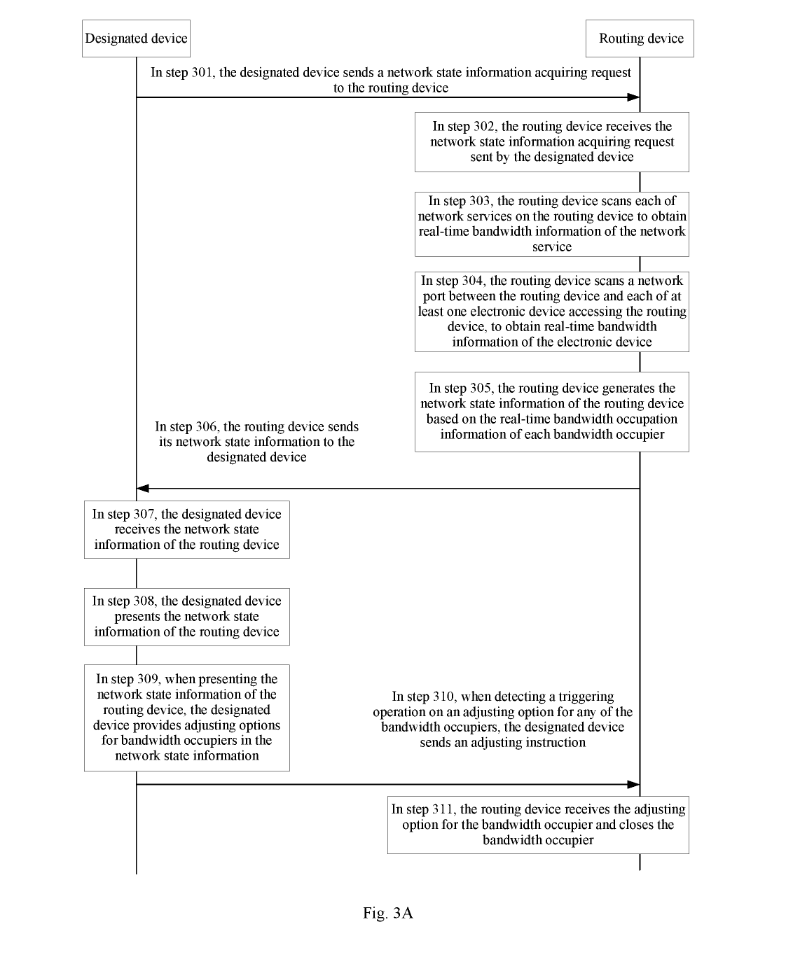

FIG. 2 is a flow chart showing a network state information retrieval and display method according to an exemplary embodiment. As shown in FIG. 2, the network state information retrieval and display method is used in an electronic device and may include the following steps.

In step 201, network state information of a routing device is received.

In step 202, the network state information of the routing device is displayed.

In the method according to this embodiment, by performing statistics on its actually occupied bandwidth or detecting the real-time occupied bandwidth for each service, the routing device obtains network state information which includes real-time bandwidth occupation and the routing device provides the network state information to a terminal, making the network state readily available to network users and avoiding misleading them.

In a possible implementation, displaying the network state information of the routing device may include: according to bandwidth occupiers in the network state information of the routing device, displaying network state information of each of the bandwidth occupiers respectively. Sometimes, the network state information may be sent to be displayed in a remote user interface on a wireless smart device.

In a possible implementation, the method may further include: when displaying the network state information of the routing device, providing adjusting options for adjusting bandwidth occupations of bandwidth occupiers in the network state information; and when a triggering operation is detected on an adjusting option for any of the bandwidth occupiers, sending an adjusting instruction to the routing device to close the bandwidth occupier corresponding to the triggering operation.

Sometimes, rather than closing the bandwidth occupier associated with the triggering operation, the bandwidth occupier may be adjusted to occupy less bandwidth according to the adjusting options. For example, if an adjusting option is received for adjusting a photo download service, rather than closing the photo download service, the bandwidth occupied by the photo download service may be adjusted to occupy a smaller bandwidth, thus the photo download service may still be performed by occupying a smaller bandwidth. For this case, only part of bandwidth occupied by the photo download service is freed up and it may take longer period of time to download the photo.

As another option, the photo download service may be suspended, thus, after receiving a triggering instruction, the photo download service is suspended, the bandwidth occupied by the photo download service is freed up, but the photo download service may be resumed at a later time when the network bandwidth is available. For this case, the partially downloaded photo may be saved on data storage and when the photo download service is resumed, the download may only be performed for the portion which has not been downloaded, thus the saved partially downloaded photo does not need to be downloaded again. The photo download service may be suspended and resumed for one time or for multiple times.

In a possible implementation, before receiving the network state information for the routing device, the method may further include: sending a network state information acquiring request to the routing device, so that the routing device returns the network state information. The network state information acquiring request may be sent to the routing device via wireless network from a remote smart device. For example, if a mobile phone user would like to find out the bandwidth usage of a remote network system, the mobile phone may be used to send a network state information acquiring request to the routing device of the remote network system, the mobile phone may also be the device for displaying the bandwidth usage for the remote network system, the mobile phone may also be used to enter instructions to adjust the bandwidth usage. The mobile phone may be any smart devices such as a smart watch, a tablet, a smart television, a virtual reality device or any other devices having a user display and means for accepting the user input. The user input may be performed via a voice recognition method or virtual reality recognition means other than entering the input manually.

All the above optional implementations may be combined in any manner to form an optional embodiment of the present disclosure, which will not be described here redundantly.

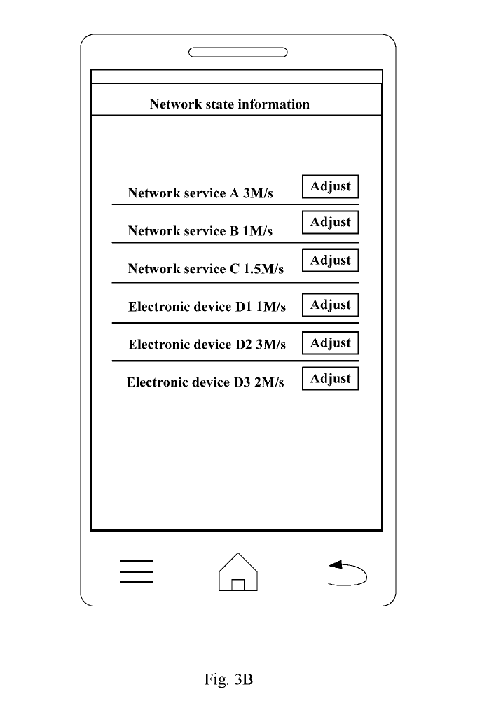

FIG. 3A is a flow chart showing a network state information retrieval and display method according to an exemplary embodiment. As shown in FIG. 3A, the network state information retrieval and display method is described by taking an example where a routing device interacts with a designated device and may include the following steps.

In step 301, the designated device sends a network state information acquiring request to the routing device.

The designated device may be any kind of electronic device and may have an application for controlling the routing device installed thereon. By running the application and triggering a querying function of querying a current network state, a user can send a network state information acquiring request to the routing device.

In step 302, the routing device receives the network state information acquiring request sent by the designated device.

In the embodiment of the present disclosure, the designated device may be an electronic device accessing the routing device or an electronic device which is associated with the routing device but is not connected to a network via the routing device. The disclosure is not limiting in this regard.

In the embodiment of the present disclosure, description is given by taking merely one example where the routing device is triggered by the network state information acquiring request sent by the designating device to perform step 303. However, in fact, this process may also be performed at a predetermined period, for example, every 1 hour or every 24 hours. As such, without introducing a designated device, network state information can be obtained periodically for monitoring the network state, and thus network state abnormity can be detected in time. For example, when the network bandwidth detection is run every day, the average network bandwidth may be calculated, when the network bandwidth is abnormally high or abnormally low, an alert may be triggered and may be sent to the user.

In step 303, the routing device scans each of network services on the routing device to obtain real-time bandwidth information of the network service.

The routing device itself may be a server. By means of the network services on the routing device, network activities (such as downloading, uploading, synchronization with a cloud server and an electronic device, etc.) which are not limited by the embodiment of the present disclosure are performed. Network services installed on the routing device need to be detected in real time, thus the knowledge of the real-time bandwidth information of each network service is obtained.

The real-time bandwidth information may refer to a sum of the current upload and download speeds. Also, the real-time bandwidth information may include other information on bandwidth occupation, such as a bandwidth reserved for a network service.

In step 304, the routing device scans a network port between the routing device and each of at least one electronic device accessing the routing device, to obtain real-time bandwidth information of the electronic device.

The routing device may provide network accessing services to electronic devices. Each of the electronic devices can be connected to the network via a network port provided by the routing device. Network services accessing the routing device need to be detected in real time, thus, the knowledge of the real-time bandwidth information of each network service is obtained.

Real-time bandwidth information of an electronic device may refer to a sum of the current upload and download speeds of the electronic device.

Further, by way of the scanning, device information of the at least one electronic device, such as device name, may also be obtained and provided to the designated device, in order for the designated device to get information on bandwidth occupation of each electronic device.

The above steps 303 and 304 constitute the process of acquiring real-time bandwidth occupation information of each of bandwidth occupiers associated with the routing device. Here, network services on a routing device and electronic devices accessing the routing device may be considered bandwidth occupiers. However, there may also be other devices or processes occupying the routing device's bandwidth, such as system threads. Therefore, other bandwidth occupying functions may also be obtained as bandwidth occupiers, to ensure accuracy of bandwidth information.

In step 305, the routing device generates the network state information of the routing device based on the real-time bandwidth occupation information of each bandwidth occupier.

For example, the step 305 may be implemented by: for each bandwidth occupier, summing the real-time bandwidth occupation information of the bandwidth occupier to obtain network state information of the bandwidth occupier, and integrating the network state information of the bandwidth occupiers to obtain the network state information of the routing device.

Because real-time bandwidth occupation information of a bandwidth occupier is used to characterize different functions of the bandwidth occupier (e.g., occupation of bandwidth by uploading or downloading), the real-time bandwidth occupation information of each bandwidth occupier needs to be summed to obtain the bandwidth occupied by the bandwidth occupier. For example, if a data transmission function has a real-time upload speed of 1 M/s and a real-time download speed of 2 M/s, its network state information is 3 M/s.

Integrating the network state information of the bandwidth occupiers to obtain the network state information of the routing device may be generating a list of correspondences between bandwidth occupiers and respective network state information.

Integrating may also be generating a listing page, namely, a page containing a list of correspondences between bandwidth occupiers and respective network state information. The page may be displayed in a single-page display mode or a paging display mode, which will be described more in detail in the following step 308.

In step 306, the routing device sends its network state information to the designated device.

In step 307, the designated device receives the network state information of the routing device.

The above steps 306 and 307 may constitute transmission of the network state information between the routing device and the designated device.

It shall be noted that the sending and the receiving may be based on any kind of network connection between the designated device and the routing device, such as NFC, Bluetooth, WiFi, etc., which are not limited by the present disclosure.

In step 308, the designated device displays the network state information of the routing device.

The displaying may be single-page display or paging display. The single-page display refers to displaying bandwidth occupiers and respective network state information in one page.

For example, bandwidth occupiers and their respective network state information obtained currently are as follows:

Network service A, network state information 3 M/s;

Network service B, network state information 1 M/s;

Network service C, network state information 1.5 M/s;

Electronic device D1, network state information 1 M/s;

Electronic device D2, network state information 3 M/s;

Electronic device D3, network state information 2 M/s.

For the above content, a page containing the list of correspondences may be generated, as shown in FIG. 3B.

On the other hand, the paging display may refer to first displaying different bandwidth occupier types and a sum of network state information for each bandwidth occupier type. When a user's triggering operation on a certain type is detected, the bandwidth occupiers belonging to this type and their respective network state information are displayed. The different types may refer to a network service type and an electronic device type.

Referring to the above example, pages for the paging display may be as shown in FIGS. 3C and 3D. As shown in FIGS. 3C and 3D, when a user's triggering operation on type T1 is detected, bandwidth occupiers belonging to the type T1 and their respective network state information are displayed.

The above process illustrates the display of the network state information on the designated device. The process enables the user to view the current actual bandwidth occupation condition of the routing device intuitively and thus allowing a high information visibility. Further, to enable the user to perform more flexible control, the method may further comprise the following steps 309-311.

In step 309, when displaying the network state information of the routing device, the designated device provides adjusting options for adjusting bandwidth occupations of bandwidth occupiers in the network state information.

In step 310, when detecting a triggering operation on an adjusting option for any of the bandwidth occupiers, the designated device sends an adjusting instruction to the routing device to close the bandwidth occupier corresponding to the triggering operation.

The above page may further include adjusting options for bandwidth occupiers, as shown in FIG. 3B. The designated device having the right to control the routing device can satisfy its current network usage demand by closing some bandwidth occupiers. The closing may not only refer to closing a network service but also may refer to cutting off a connection between a network port and an electronic device.

In step 311, the routing device receives the adjusting option for the bandwidth occupier and closes the bandwidth occupier.

When receiving the adjusting option for the bandwidth occupier, the routing device may close the bandwidth occupier according to a closing procedure set by itself.

It shall be noted that the closing procedure set by the routing device may be temporary closing. That is, a closed network service may resume its network function under the instruction of the designated device. This embodiment is not limiting in this regard. The closing manner set by the routing device may also be closing based on the priority. For example, a priority is set for each routing service, and when a routing service is closed, the lowest priority routing service is selected. There are other methods to select the routing service to be closed which is not limited by the embodiment of the present disclosure.

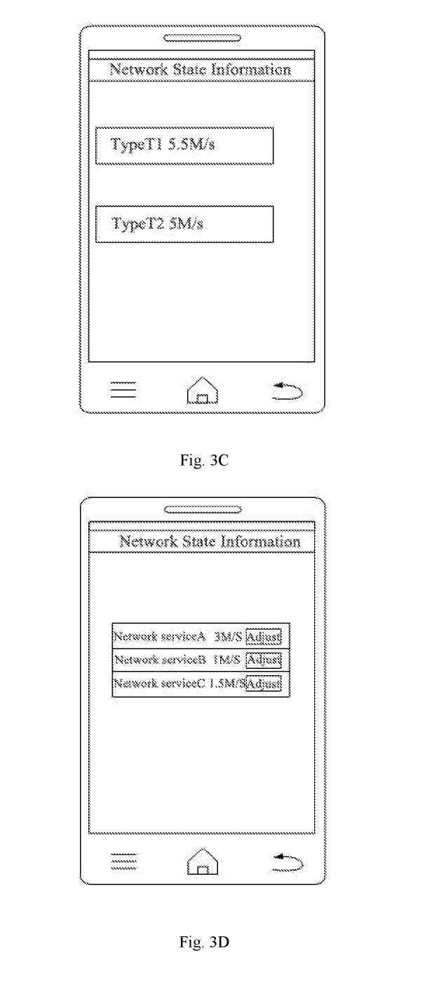

FIG. 4 is a block diagram showing a network state information retrieval and display apparatus according to an exemplary embodiment. Referring to FIG. 4, the apparatus may include an acquiring module 401, a generating module 402 and a sending module 403.

The acquiring module 401 is configured to acquire real-time bandwidth occupation information of each of bandwidth occupiers associated with a routing device. The bandwidth occupiers may include one or more network services on the routing device and at least one electronic device accessing the routing device.

The generating module 402 is configured to generate network state information of the routing device, based on the real-time bandwidth occupation information of each bandwidth occupier. The real-time bandwidth occupation information may be acquired by the acquiring module 401.

The sending module 403 is configured to send the network state information of the routing device generated by the generating module to a designated device, so that the designated device displays the network state information.

In a possible implementation, the generating module 402 is configured to: for each bandwidth occupier, sum the real-time bandwidth occupation information of the bandwidth occupier to obtain network state information of the bandwidth occupier, and integrate or aggregate the network state information of the bandwidth occupiers to obtain the network state information for the routing device.

In a possible implementation, the acquiring module 401 is configured to: scan each of the network services on the routing device to obtain real-time bandwidth information of the network service; scan a network port between the routing device and each of the at least one electronic device accessing the routing device to obtain real-time bandwidth information for the electronic device.

In a possible implementation, the acquiring module 401 is configured to: acquire the real-time bandwidth occupation information of each of the bandwidth occupiers associated with the routing device, when a network state information acquiring request sent by the designated device is received. The acquiring module 401 may be configured to acquire the real-time bandwidth occupation information of each of the bandwidth occupiers associated with the routing device at a predetermined time period.

In a possible implementation, the apparatus may further include: a processing module configured to close the bandwidth occupier when an adjusting instruction for any of the bandwidth occupiers is received.

In a possible implementation, the real-time bandwidth occupation information may refer to a sum of the upload speed and the download speed. The real-time bandwidth occupation information may also be a sum of the upload speed or a sum of the download speed.

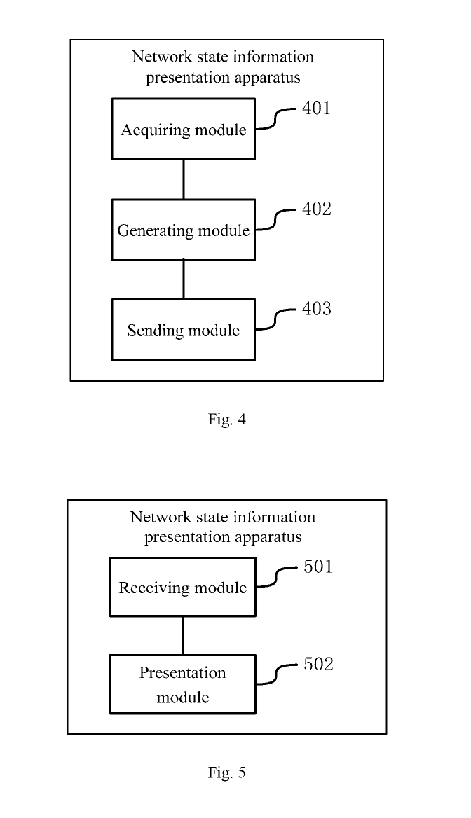

FIG. 5 is a block diagram showing a network state information retrieval and display apparatus according to an exemplary embodiment. Referring to FIG. 5, the apparatus may include the following modules.

A receiving module 501 is configured to receive network state information of a routing device.

A presentation module 502 is configured to display the network state information for the routing device received by the receiving module.

In a possible implementation, the presentation module is configured to: according to bandwidth occupiers in the network state information of the routing device, display network state information of each of the bandwidth occupiers respectively.

In a possible implementation, the apparatus may further include: a providing module configured to provide adjusting options for adjusting bandwidth occupations of bandwidth occupiers in the network state information when the network state information for the routing device received by the receiving module is displayed. A first sending module configured to, when a triggering operation on an adjusting option for any of the bandwidth occupiers is detected, send an adjusting instruction to the routing device to close the bandwidth occupier corresponding to the triggering operation.

In a possible implementation, the apparatus may further include: a second sending module configured to send a network state information acquiring request to the routing device, so that the routing device returns the network state information.

Detailed operations performed by modules of the apparatus in the above embodiments have been described in related method embodiments, and will not be described here in detail any more.

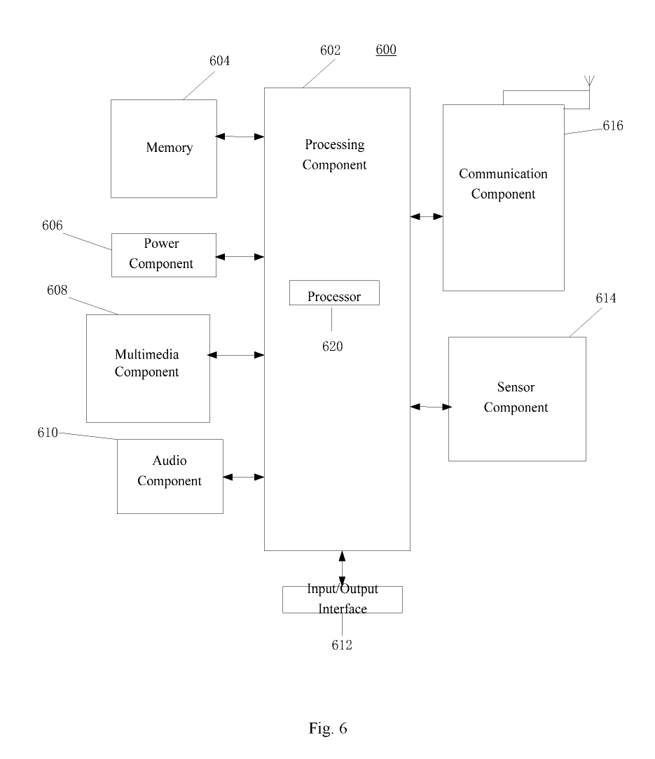

FIG. 6 is a block diagram showing a network state information retrieval and display apparatus 600 according to an exemplary embodiment. For example, the apparatus 600 may be a mobile phone, a computer, a digital broadcast terminal, a messaging device, a gaming console, a tablet, a medical device, exercise equipment, a personal digital assistant or the like.

Referring to FIG. 6, the apparatus 600 may include one or more of the following components: a processing component 602, a memory 604, a power component 606, a multimedia component 608, an audio component 610, an input/output (I/O) interface 612, a sensor component 614 and a communication component 616.

The processing component 602 generally controls the overall operations of the apparatus 600, for example, display, phone call, data communication, camera operation and record operation. The processing component 602 may include one or more processors 620 to implement an instruction to complete all or part of the steps of the above methods. In addition, the processing component 602 may include one or more modules to facilitate the interaction between the processing component 602 and other components. For example, the processing component 602 may include a multimedia module to facilitate the interaction between the processing component 608 and the processing component 602.

The memory 604 is configured to store various types of data to support the operation performed on the device 600. The examples of such data include an instruction of any application program or method, contact data, address book data, massages, pictures, videos, etc. which are operated on the device 600. The memory 604 may be realized with any kind of a volatile and non-volatile storage device or combination thereof, for example, Static Random Access Memory (SRAM), Electrically-Erasable Programmable Read Only Memory (EEPROM), Erasable Programmable Read Only Memory (EPROM), Programmable Read Only Memory (PROM), Read Only Memory (ROM), a magnetic memory, a flash memory, a magnetic disk or an optical disk.

The power component 606 provides power for various components of the apparatus 600. The power component 606 may include a power supply management system, one or more power supplies, and other components for generating, managing and distributing power to the apparatus 600.

The multimedia component 608 includes a screen providing an output interface between the apparatus 600 and the user. In some embodiments, the screen may include a Liquid Crystal Display (LCD) and a Touch Panel (TP). If the screen includes the touch panel, the screen may be realized as a touch screen to receive input information from the user. The touch panel includes one or more touch sensors to sense the touching, sliding and the gestures on the touch panel.

The touch sensor may not only sense the touching or border of sliding gesture but also detect the duration time and pressure related to touching or sliding operation. In some embodiments, the multimedia component 608 includes one front-facing camera and/or one rear-facing camera. When the apparatus 600 is in an operation mode, for example, a shooting mode or a video mode, the front-facing camera and/or the rear-facing camera may receive outside multimedia data. Each one of front-facing camera and rear-facing camera may be one fixed optical lens system or have focal length or optical zoom ability.

The audio component 610 is configured to output and/or input audio information. For example, the audio component 610 includes one microphone (MIC). When the apparatus 600 is in the operation mode, for example, a calling mode, a record mode and a speech recognition mode, the microphone is configured to receive outside audio information. The received audio information may be further stored in the memory 604 or sent via the communication component 616. In some embodiments, the audio component 610 may include a speaker configured to output audio information.

The I/O interface 612 provides an interface between the processing component 602 and a peripheral interface module. The above peripheral interface module may be a keyboard, a click wheel, and button, etc. The button may include but not limit to home page button, volume button, start button and lock button.

The sensor component 614 includes one or more sensors and is configured to provide various aspects of the assessment state for the apparatus 600. For example, the sensor component 614 may detect the on/off state of the apparatus 600, the relative positioning of the components (for example, the components are display and a keypad of the apparatus 600), position change of the apparatus 600 or one component of the apparatus 600, presence or absence of the touch between the user and the apparatus 600, as well as the orientation or acceleration/deceleration and temperature change of the apparatus 600. The sensor component 614 may include a proximity sensor configured to detect the presence of an adjacent object when there is not any physical contact. The sensor component 614 may also include an optical sensor (such as CMOS or a CCD image sensor) configured to be used in imaging application. In some embodiments, the sensor component 614 may also include an acceleration sensor, a gyro sensor, a magnetic sensor, a pressure sensor or a temperature sensor.

The communication component 616 is configured to facilitate the wired or wireless communication between the apparatus 600 and other apparatuses. The apparatus 600 may access the wireless network based on a communication standard, such as WiFi, 2G or 3G, or a combination thereof. In one exemplary embodiment, the communication component 616 receives a broadcast information or broadcast associated information from an external broadcast management system via a broadcast channel. In one exemplary embodiment, the communication component 616 also includes a Near Field Communication (NFC) module to facilitate short-range communication. For example, the NFC module may be based on Radio Frequency Identification (RFID) technology, Infrared Data Association (IrDA) technology, Ultra-Wideband (UWB) technology, Bluetooth (BT) technology and other technologies.

In an exemplary embodiment, the apparatus 600 may be realized through one or more circuitries, which include an Application Specific Integrated Circuits (ASIC), a Digital Signal Processor (DSP), a Digital Signal Processing Device (DSPD), a Programmable Logic Device (PLD), a Field Programmable Gate Array (FPGA), a controller, a microcontroller, a microprocessor, or other electronic elements. The apparatus may use the circuitries in combination with the other hardware or software components for performing the above described methods. Each module, sub-module, unit, or sub-unit in the disclosure may be implemented at least partially using the one or more circuitries.

In an exemplary embodiment, a non-transitory computer-readable storage medium comprising the instruction is also provided, for example, the memory 604 including the instruction. The above instruction may be carried out by the processor 620 of the apparatus 600 to perform the above methods. For example, the non-transitory computer-readable storage medium may be a ROM, a random access memory (RAM), a CD-ROM, a magnetic tape, a floppy disk, an optical data storage devices and the like.

In an embodiment, there is also provided a non-transitory computer-readable storage medium having stored therein instructions that, when executed by a processor of a mobile terminal, cause the mobile terminal to perform the network state information retrieval and display method performed by an electronic device as shown in FIG. 2 or 3.

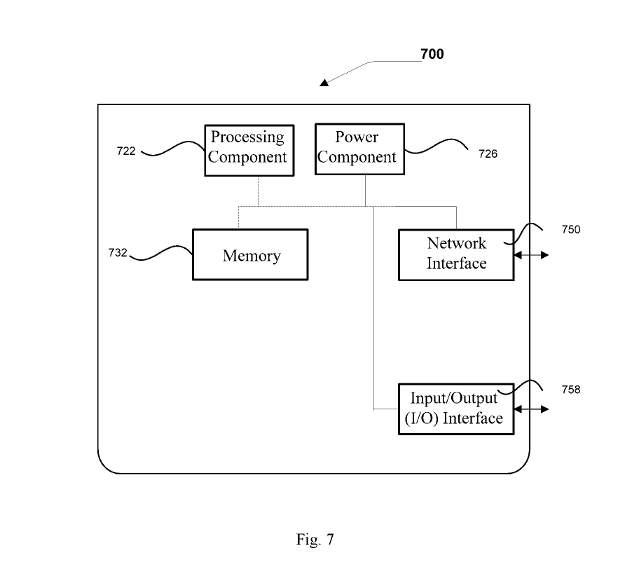

FIG. 7 is a block diagram showing a network state information retrieval and display apparatus 700 according to an exemplary embodiment. For example, the apparatus 700 may be provided as a router. Referring to FIG. 7, the server 700 includes a processing component 722 which further includes one or more processors, and memory resources that a memory 732 represents for storing instructions executable by the processing component 722, e.g., applications. The applications stored in the memory 732 may include one or more modules each corresponding to a set of instructions. In addition, the processing component 722 is configured to execute instructions, so as to perform the network state information retrieval and display method performed by a routing device as shown in FIG. 1 or 3.

The apparatus 700 may further include a power component 726 configured to perform power management for the apparatus 700, a wired or wireless network interface 750 configured to connect the apparatus 700 to a network, and an input/output (I/O) interface 758. The apparatus 700 can be operated based on an operating system stored in the memory 732, e.g., Windows Server™, Mac OS X™, Unix™, Linux™, FreeBSD™ or the like.

Those skilled in the art may easily conceive other embodiments of the disclosure from consideration of the specification and practice of the present disclosure. This application is intended to cover any variations, uses, or adaptations of the disclosure following the general principles thereof and including such departures from the present disclosure as come within known or customary practice in the art. The specification and examples are intended to be exemplary only, with a true scope and spirit of the disclosure being indicated by the following claims.

By performing statistics on its actual occupied bandwidth, the routing device obtains network state information having real-time bandwidth occupation and provides the network state information to a terminal, making the network state available to network users and prevent the network users from being misled. The present disclosure may include dedicated hardware implementations such as application specific integrated circuits, programmable logic arrays and other hardware devices. The hardware implementations can be constructed to implement one or more of the methods described herein. Applications that may include the apparatus and systems of various embodiments can broadly include a variety of electronic and computing systems. One or more embodiments described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The term “module” or “unit” may include memory (shared, dedicated, or group) that stores code executed by the processor.

It will be appreciated that the present disclosure is not limited to the exact construction that has been described above and illustrated in the accompanying drawings, and that various modifications and changes can be made without departing from the scope thereof. It is intended that the scope of the disclosure is not limited by the appended claims.

What is claimed is:

1. A method for retrieving and displaying network state information, comprising:
acquiring real-time bandwidth occupation information of each of bandwidth occupiers associated with a routing device, the bandwidth occupiers comprising one or more network services on the routing device and at least one electronic device accessing the routing device;
generating network state information for the routing device based on the real-time bandwidth occupation information of each bandwidth occupier; and
sending the network state information for the routing device to a designated device, so that the designated device displays the network state information.

2. The method of claim 1, wherein generating the network state information of the routing device based on the real-time bandwidth occupation information of each bandwidth occupier comprises:
for each bandwidth occupier, summing the real-time bandwidth occupation information of the bandwidth occupier to obtain network state information of the bandwidth occupier; and
integrating the network state information of the bandwidth occupiers to obtain the network state information for the routing device.

3. The method of claim 1, wherein acquiring the real-time bandwidth occupation information of each of the bandwidth occupiers associated with the routing device comprises:
scanning each of the network services on the routing device to obtain real-time bandwidth information of the network service; and
scanning a network port between the routing device and each of the at least one electronic device accessing the routing device to obtain real-time bandwidth information of the electronic device.

4. The method of claim 1, wherein acquiring the real-time bandwidth occupation information of each of the bandwidth occupiers associated with the routing device comprises:
acquiring the real-time bandwidth occupation information of each of the bandwidth occupiers associated with the routing device when a network state information acquiring request is received from the designated device; or
acquiring the real-time bandwidth occupation information of each of the bandwidth occupiers associated with the routing device at a predetermined period.

5. The method of claim 1, after sending the network state information of the routing device to the designated device, further comprising:
upon receiving an adjusting instruction for one of the bandwidth occupiers, closing the bandwidth occupier.

6. The method of claim 1, wherein the real-time bandwidth occupation information indicates a sum of an upload speed and a download speed.

7. A network state information retrieval and display method, comprising:
receiving network state information for a routing device; and
displaying the network state information for the routing device.

8. The method according to claim 7, wherein displaying the network state information of the routing device comprises:
according to bandwidth occupiers in the network state information of the routing device, displaying network state information of each of the bandwidth occupiers respectively.

9. The method according to claim 7, further comprising:
when displaying the network state information of the routing device, providing adjusting options for adjusting bandwidth occupations of bandwidth occupiers in the network state information; and
when detecting a triggering operation on an adjusting option for one of the bandwidth occupiers, sending an adjusting instruction to the routing device to close the one of the bandwidth occupiers corresponding to the triggering operation.

10. The method according to claim 7, before receiving the network state information of the routing device, further comprising:
sending a network state information acquiring request to the routing device, so that the routing device returns the network state information.

11. An apparatus, comprising:
a processor;
a memory configured to store instructions executable by the processor,
wherein the processor is configured to
acquire real-time bandwidth occupation information of each of bandwidth occupiers associated with a routing device, the bandwidth occupiers comprising one or more network services on the routing device and at least one electronic device accessing the routing device;
generate network state information for the routing device, based on the real-time bandwidth occupation information of each bandwidth occupier; and
send the network state information for the routing device to a designated device, so that the designated device displays the network state information.

12. The apparatus of claim 11, wherein the processor is configured to:
for each bandwidth occupier, sum the real-time bandwidth occupation information of the bandwidth occupier to obtain network state information of the bandwidth occupier; and
integrate the network state information of the bandwidth occupiers to obtain the network state information for the routing device.

13. The apparatus of claim 11, wherein the processor is configured to:
scan each of the network services on the routing device to obtain real-time bandwidth information of the network service; and
scan a network port between the routing device and each of the at least one electronic device accessing the routing device to obtain real-time bandwidth information of the electronic device.

14. The apparatus of claim 11, wherein the processor is configured to:
acquire the real-time bandwidth occupation information of each of the bandwidth occupiers associated with the routing device, when receiving a network state information acquiring request sent by the designated device; or acquire the real-time bandwidth occupation information of each of the bandwidth occupiers associated with the routing device at a predetermined period.

15. The apparatus of claim 11, wherein the processor is configured to: after sending the network state information for the routing device to the designated device, close the bandwidth occupier when receiving an adjusting instruction for one of the bandwidth occupiers.

16. The apparatus of claim 11, wherein the real-time bandwidth occupation information indicates a sum of an upload speed and a download speed.

17. The apparatus of claim 12, wherein the real-time bandwidth occupation information indicates a sum of an upload speed and a download speed.

18. The apparatus of claim 13, wherein the real-time bandwidth occupation information indicates a sum of an upload speed and a download speed.

19. The apparatus of claim 14, wherein the real-time bandwidth occupation information indicates a sum of an upload speed and a download speed.

20. The apparatus of claim 15, wherein the real-time bandwidth occupation information indicates a sum of an upload speed and a download speed.
